(19) United States
(12) Patent Application Publication
(10) Pub. No.: US 2008/0134552 A1
(43) Pub. Date: Jun. 12, 2008

(54) Garment display window and related method

(76) Inventor: Pamela M. Lough, Huntington Beach, CA (US)

Correspondence Address: J. MARK HOLLAND AND ASSOCIATES, 3 SAN JOAQUIN PLAZA, SUITE 210, NEWPORT BEACH, CA, 92660, US

(21) Appl. No.: 11/636,164

(22) Filed: Dec. 8, 2006

(51) Int. Cl. G09F 21/02

(52) U.S. Cl. 40/586

(57) ABSTRACT

The invention described herein generally relates to clothing, garments, or accessory items worn on the body of a person. The garment, preferably, a shirt, a pair of pants, or a dress includes a section or portion of the clothing material cut-out to form an opening or window in the garment. Preferably, items such as jewelry, ribbons, charms, chains, pendants, or other types of ornamentation for dressing or decorating the window are removably attached to the inside of the window by an attaching means such as clasps, Velcro®, hooks, tape, etc. Such temporary attachment of items within the window permits other items to be interchangeably associated with the window. Articles for window display may relate to a holiday, birthday, and/or special occasion theme or an expression of the individual wearer's emotional state.

### FIELD OF THE INVENTION

The present invention relates generally to clothing, and more particularly, the present invention relates to a garment having a window or opening formed therein for the removable display of articles or items of ornamentation other than only indicia within a portion of the window. In one embodiment, the combination of window and related display item(s) preferably corresponds to a related mood, activity, event, or occasion such as a holiday, birthday, or emotion.

### BACKGROUND OF THE INVENTION

Clothing comes in a wide variety of styles and configurations. There are numerous garments and clothing options, each of which may be suitable for a variety of occasions and activities. The style, size, and configuration of an individual's clothing (including cut, color combinations, and fabric/material type, for example) can present an image for the rest of the world to scrutinize and assess. Accordingly, clothing can provide individuals a means of self-expression of their own style and uniqueness.

Such clothing or garment options that arguably provide for some measure of garment modification and self-expression include: (1) a garment having a flat panel and a transparent window attached thereto for the removable display of indicia therebetween, as described in U.S. Pat. No. 4,924,613, issued to Levin on May 15, 1990; (2) a garment having a window box formed therein for the detachable mounting of a monogram piece behind the window box, as described in U.S. Pat. No. 2,936,460, issued to Jackson on May 17, 1960; (3) clothing having a toy animal interrelated with a design on the clothing depicting the animals habitat, as described in U.S. Pat. No. 6,038,698 issued to Lawler on Mar. 21, 2000; and (4) a pair of pants having substantially-horizontal apertures positioned in spaced vertical relationship adjacent to the outer perimeters or seams of the pants for removable attachment of ornamentation.

Although the aforementioned prior art references generally describe various methods for garment modification to change the appearance of the garment while presenting some form of garment design, ornamentation, and/or self-expression, the references cited and others known to the inventor do not provide for a garment having a window or opening formed therein for the removable display of articles or items of ornamentation other than only indicia within a portion of the window. In this regard, in one embodiment, the combination of window and related display item(s) preferably correspond to a related mood, activity, event, and/or occasion such as a holiday, birthday, or emotion.

### SUMMARY OF THE INVENTION

For the purpose of summarizing the invention certain objects and advantages have been described herein. It is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

The invention described herein generally relates to clothing or garments worn on the body of a person. The clothing or garment, preferably, a shirt, a pair of pants, or a dress includes a section or portion of the clothing material cut-out to form an opening or window in the garment. Preferably, display items such as jewelry, ribbons, charms, chains, pendants, or other types of ornamentation for dressing or decorating the window are removably attached to an edge or border, preferably the inside hem, of the window by an attaching means such as clasps, Velcro®, hooks, tape, etc. Such temporary attachment of display items permits those items to be displayed within a portion of the window and other type items to be interchangeably associated with the window. Articles for window display may relate to holiday, birthday, and special occasion themes, or an expression of the individual wearer's emotional state.

Persons of ordinary skill in the art will understand that the window display invention described herein may be adapted to display articles in other garments such as hats, boots (footwear), handbags or luggage, and similar items. In addition, it is further understood that the window may be structurally adapted, as described below, to display items such as an Ipod®, cellphone, a make-up compact, keys, a mini-flashlight, and the like.

The window may further include: (1) a corresponding backing material having a variation of color, texture, or design permanently or detachably affixed to the back of the window to enhance or otherwise provide another measure of theme continuity and visual interest, (2) a frame or trim along a portion of the outer edge or border to simulate an actual window frame, and/or (3) a curtain or shade that can be pulled back or drawn up to expose the item for display within the window. Alternatively, the window may remain unfinished.

These and other embodiments will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is a perspective view showing a garment having an opening or window formed therein and an item other than only indicia for display within a portion of the window in accordance with one embodiment of the present invention.

FIG. 2A shows an enlarged view of the opening or window having an item other than only indicia for display formed within the garment of FIG. 1.

FIG. 2B is a sectional view of FIG. 2A taken along a line through 3-3, on an enlarged scale.

FIG. 2C shows and alternative embodiment of present invention having a hem including a separate stiffening member sewn into the window or opening formed by the removal of material from a garment or other item.

FIG. 3A illustrates an alternative embodiment of the present invention having a frame or trim position along the perimeter of the window.

FIG. 3B is a sectional view of FIG. 3A taken along a line through 3-3, on an enlarged scale.

FIG. 4A shows an alternative embodiment of the present invention having two windows formed in a garment, each window including window backing material and a item for display within a portion of the window.

FIG. 4B is a sectional view of FIG. 4A taken along a line through 3-3, on an enlarged scale.

FIG. 5 shows an example of a curtain or shade that may be pulled back to expose the item for display within the window.

### DETAILED DESCRIPTION

Embodiments of the present invention will now be described with references to the accompanying Figures, wherein like reference numerals refer to like elements throughout. The terminology used in the description presented herein is not intended to be interpreted in any limited or restrictive manner, simply because it is being utilized in conjunction with a detailed description of certain embodiments of the invention. Furthermore, various embodiments of the invention (whether or not specifically described herein) may include novel features, no single one of which is solely responsible for its desirable attributes or which is essential to practicing the invention herein described.

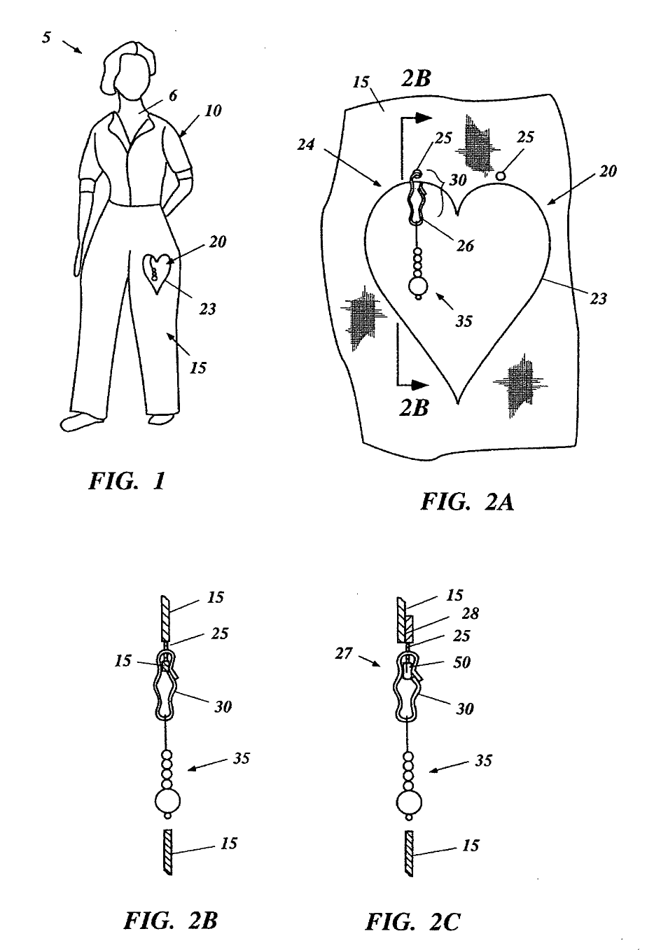

As shown in FIG. 1, the invention described herein generally relates to clothing or a garment 5 (shirt, pants, dress, boots, hat, and may further including handbags, luggage, etc.) worn on the body of a person 6. The garment 5, preferably, a shirt 10 or a pair of pants 15 includes a section or portion of the clothing material cut-out 20 to form an opening or window 23 in the garment 5 for the removable display of items 35 such as jewelry, ribbons, charms, chains, pendants, or ornamentation for dressing or otherwise decorating the window 23. In one embodiment, the structural configuration (shape, size, etc.) of the window 23 and related display item(s) preferably corresponds to a related mood, activity, event, or occasion such as a holiday, birthday, or emotion.

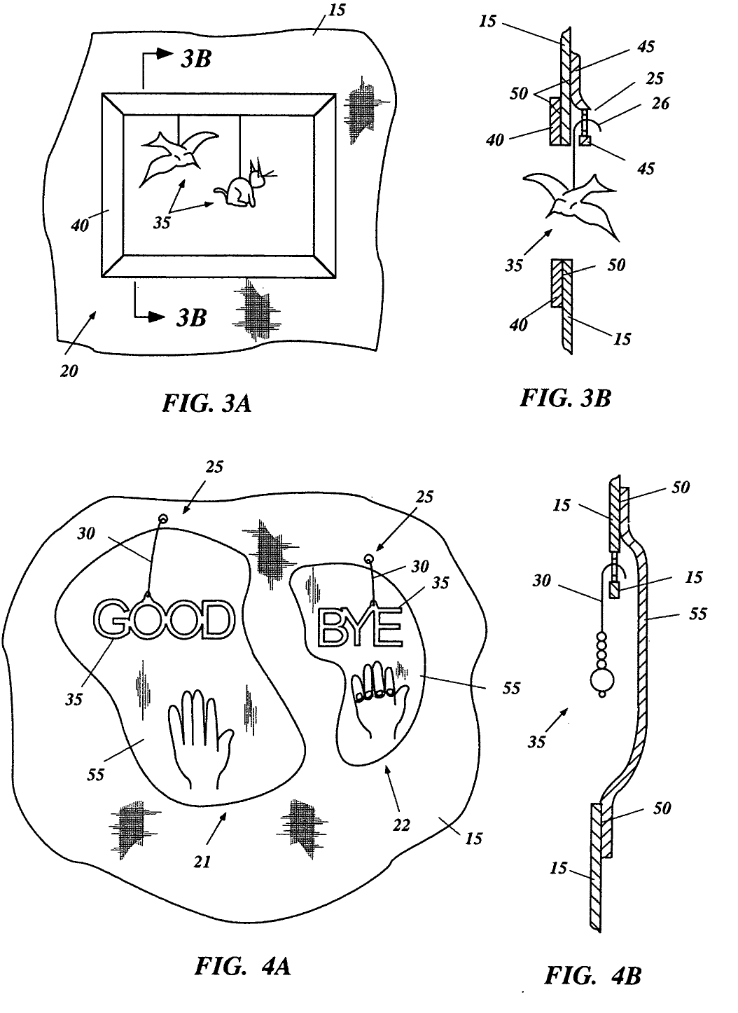

FIG. 2A shows one embodiment of the opening or window 23 having a heart shape formed in a pair of pants 15. Another embodiment of a window 23 may be rectangular in shape, as shown in FIG. 3A, or the window 23 or windows 21, 22 may possess a random shape(s) such as those shown in FIG. 4A. Persons of ordinary skill in the art will understand that the size and shape of the opening or window 23 is not limited to those shown in the drawings. Generally, the only imposed limitations on the size and shape of the window would be those that would substantially render the garment 5 ((shirt, pants, dress, boots, hat, and may further including handbags, luggage, etc.) unusable for its intended purpose. For example, an opening and/or shape so large, expansive, or convoluted so as to compromise the structural integrity/wearability of the garment 5 would typically be unsatisfactory.

Material construction of the opening or window 23 may include virtually any known fabric or material including cotton, silk, leather, latex, and rubber, to name a few. In this regard, different fabric and/or materials may be utilized in construction of the window 23, and, as explained below, the window frame 40, window backing 55, and window curtain 29.

Display items 35 such as jewelry, ribbons, charms, chains, pendants, or other types of ornamentation for dressing or decorating the window 23 are removably attached to the window 23, preferably along an edge 24, by an attaching means or more appropriately by an attaching means combination 30 such as clasps, Velcro®, hooks, tape, etc. In order to support relatively heavier items such as an Ipod®, cellphone, mini-flashlight, key, etc., the structural integrity of the window 23 may be enhanced by a hem 27 (material folded over the back of the window 23 and sewn 50 as shown in FIG. 2C). Additional strength or support for the window 23 may be achieved by the use of a stiffening member 28 such as a metal strip of similar sturdy material sewn into the hem 27.

Display items other than only indicia, are attached so that those items 35 are displayed within a portion of the window 23. In contrast to the apertures, for example those shown and described in the Grimes publication which simply provide a point of attachment for a single item of ornamentation, the windows 23 as described herein is configured to provide a vehicle to showcase one or more items 35 intended for display. In this regard, the window 23 is structured to permit all, or a portion of the item 35 to be displayed or contained within the confines of the edge or perimeter 24 of the window 23 that is defined by the garment's material 10, 15 remaining in the garment 5 after removal of a portion of the garment's material 20 to form the window 23.

As indicated above, the attachment means/combination 30 for attaching display items 35 within the opening or window 23 may take many forms. Typically, the attachment means 30 includes a single element or a combination of corresponding or structurally associated elements.

For example, the use of Velcro® typically requires attachment of hooks to one material and the attachment of corresponding or structurally associated loop members to another material so that those two materials may be temporarily joined or removably attached to each other. Likewise, in various embodiments of the present invention shown in FIGS. 2A, 2B, 3A, and 3B, a clasp or hook 26 commonly used with earrings and assorted jewelry, may be used to display an item 35 within the window 23. Preferably, this type of attaching means 30 is used in combination with an eyelet 25 for temporarily joining or removably attaching the clasp 26 to the eyelet 25 or hole along the perimeter or edge 24 of the material 15 forming the opening or window 23. Accordingly, as used herein, the term attaching means is a broad term and may refer to a single item such as a hook pushed through material forming a portion of the window, or the term attaching means may refer to one or more items individually, collectively, or in combination that make up the attaching means, such as the combination of a hook and an eyelet.

Typically, the item 35 to be displayed in the window 23 is attached to one end of the attachment means (clasp) 26 and the attachment means 30 is then received into the corresponding or structurally associated member (eyelet) 25. In some instances, as shown specifically in FIG. 3B, the attachment means (hook) 26 is formed as an integral part of the item (bird) 35 to be displayed. Accordingly, the interchangeability of items 35 with such integrally formed attachment means 30 would require the use of an additional attachment means 30 to temporarily attach other items 35 for display in the opening or window 23. Although one embodiment of the present invention provides an attachment means 30 that permits interchangeability of items within the window 23, persons of ordinary skill in the art will understand that a relatively more permanent attachment means may be utilized and still be within the spirit and scope of the present invention.

Preferably, the attaching means/combination or mechanism 30 is made of a non-tarnishing metal, composite, or plastic. In addition to the styles indicated above, the attaching means or mechanism 30 may be constructed in a variety of forms, configurations, and combination of elements, such as a hook and eye configuration, a clip mechanism, or a set of two hooks that fit together. Preferably, the attaching means 30 allows for or permits an oval or circular ring to be fitted into the hook to securely hold the window item 35 or “dressing”.

FIGS. 2B and 3B show two examples of an eyelet 25 or similar device for receiving an item 35 to be displayed in the window 23 formed, attached, or otherwise associated with the material 15 forming the opening or window 23.

In FIG. 2B the eyelet 25 is attached along a lower portion of a top edge or perimeter 24 of the window 23. This arrangement is represented in the sectional view of FIG. 2A taken along the line through 3-3, by material 15 forming the opening or window 23 located on both sides of the eyelet 25. Although the eyelet 25 is shown attached to the top edge 24 of the window 23 in FIG. 2B to allow the particular item (beads) 35 shown to hang within the window 23, the eyelet 25, or any attachment means/combination 30, or part thereof, may be positioned along any portion of the window's perimeter.

As shown in FIG. 3B, in an alternative embodiment, the attachment means 30, attachment combination, or any part thereof, may be attached by a thread or stitching 50 to a portion of material positioned behind or on the backside of the opening or window 23. In this arrangement, all or part of the attachment means 30 may be hidden when the garment 5 (shirt 10 or pants 15) is worn as normally intended.

As described herein, the temporary, removable, or interchangeable attachment of items 35 along the edge 24 of the window 23 permits the item 35 to hang within the opening or window 23, and for similar type items 35 to be interchangeably associated with the window 23. Items or articles for window display may include those relating to a holiday, birthday, and/or special occasion themes or an expression of the individual wearer's emotional state. Examples, of holiday themes may include a Christmas tree shaped window having a candy cane(s), snowman(s), or similarly related items removably attached by an attaching means 30 for temporary display within the viewing window 23. A special occasion theme may include a balloon shaped window having a cake and candles as items 35 for display within the window 23.

Persons of ordinary skill in the art will understand that the items 35 displayed themselves may convey a related theme without the opening or window 23 substantially contributing to the same theme. For example, as shown in FIG. 3A, an opening or window 23 having a generally rectangular shape and a similarly shaped frame 40 around the window's perimeter is used to display items 35 having an animal (bird and cat) theme. In this instance, the window 23 and frame 40 may showcase the item 35 displayed and arguably relate and contribute to the overall visual appeal of the window 23, however, the window's shape and frame 40 would generally not be considered as relating to the animal theme.

As indicated above, the window 23 may include a frame or trim 40 position along a portion of a front edge or perimeter 24 of the window 23 to simulate an actual window frame. In this regard, the frame 40 may be positioned along the entire perimeter of the window 23 or any portion thereof. Typically, as shown in FIG. 3B, attachment of the frame or trim 40 to the opening or window 23 is accomplished by use of thread or stitching 50, glue, tape, Velcro®, or a similar connecting means 50 that would permit, depending on the intended application, either temporary or permanent attachment of the frame or trim 40 to the opening or window 23. Alternatively, the window 23 may remain unfinished.

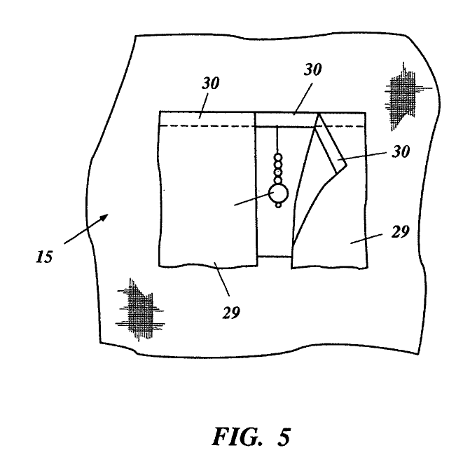

As shown in FIGS. 2A and 3A, in one embodiment, the window 23 may remain “open”, i.e., has no window backing material 55, as indicated below. Accordingly, whatever is positioned behind the window 23 is visible through the window 23. For example, if the garment 5 the person is wearing includes an “open” window as described herein, the person's skin may be visible through the window 23 or the leggings, hose, stockings, or undergarment(s) worn by the person may be visible through the window 23. Alternatively, as shown in FIGS. 4A, 4B, and 5 the window 23 may be partially or fully “closed” by the addition of a corresponding piece of window backing material 55 or curtain 29, as described below, having a variation of color, texture, or design permanently or detachably affixed to the back of the window 23 to enhance or otherwise provide another measure of theme continuity and visual interest. The window backing material 55 may further include graphics (hands waving in FIG. 4A) and/or indicia printed thereon. The window backing material 55 may be attached by thread or stitching 50 near the edge of the opening or window 23. In this regard, the window backing material 55 would typically extend across the entire window 23.

As shown in FIG. 5, in an alternative embodiment of the present invention, the window 23 may further include a curtain 29 or shade that may be pulled back or drawn up to expose or reveal the item(s) for display within the window 23. In this regard, the curtain 29 includes a portion of material movable from a first position, in which the item 35 in the window 23 is hidden from view, and a second position in which the item 35 in the window 23 is displayed. Attachment of the curtain 29 or shade may be facilitated by the use of tape, Velcro®, a zipper, or similar attaching means 30 that is used independently or in combination with the attaching means to removably attach the item 35 for display within the window 23.

One method of the present invention includes removing a portion of material 20 in a garment (shirt, pants, dress, boots, hat, and may further including handbags, luggage, etc.) to form an opening or window 23 in the garment 5 defined by material remaining in the garment after removal of the garment's material. In this regard, removing generally means to cut-out or otherwise excise and discard a portion of the garment material 20 so that the removed portion of material is no longer a part of the original garment material. The method further includes the steps of (1) associating or removably attaching a first item 35 other than only indicia to the window 23 formed in the garment 5 so the first item 35 is displayed within a portion of the window 23, (2) removing the first item 35 displayed in the window 23; and (3) associating or removably attaching a second item 35 other than indicia for display in the window 23 so the second item 35 is displayed within a portion the window 23, or (4) retaining the first item 35 in the window 23 and associating or removably attaching a second item 35 to the window 23 formed in the garment 5 so the second item 35 is displayed within a portion of the window 23.

The apparatus and methods of the present invention have been described with some particularity, but the specific designs, constructions and steps disclosed are not to be taken as delimiting of the invention. Obvious modifications will make themselves apparent to those of ordinary skill in the art, all of which will not depart from the essence of the invention and all such changes and modifications are intended to be encompassed within the appended claims.

1. An article for displaying items, comprising:
a garment;
a window formed in the garment;
a first item other than only indicia attached to the garment so as to hang for display within a portion of the window.

2. The article of claim 1, wherein the first item is removably attached to the garment.

3. The article of claim 1, further including a frame positioned around the perimeter of the window.

4. (canceled)

5. The article of claim 1, further including a curtain positioned in front of the window, the curtain having a first position in which the item in the window is hidden from view and a second position in which the item in the window is displayed.

6. The article of claim 2, further including a second item attached to the garment so as to hang for display within a portion of the window.

7. The article of claim 6, wherein the second item is removably attached to the garment.

8. The article of claim 7, wherein the window, first item, and second item are configured to relate to one of a common holiday, birthday, special occasion, or an emotional state.

9. A garment comprising:
a window formed in the garment, the window defined by material remaining in the garment after removal of a portion of the garment's material;
a first item other than only indicia removably attached to the garment for display of the first item within the window; and
an attaching means that permits for the removable attachment of the first item and interchangeability of the first item with a second item for display of the second item within the window.

10. The garment of claim 9, further including a window backing portion positioned behind the window and attached to the garment along a portion of the perimeter of the window.

11. The garment of claim 9 further including a curtain positioned in front of the window, the curtain having a first position in which the item or items in the window are hidden from view and a second position in which the item or items in the window are displayed.

12. A method of displaying items on a garment, comprising the steps of:
forming a window in a garment;
removably attaching a first item other than only indicia to the garment so the first item hangs for display within a portion of the window.

13. The article of claim 1, wherein the first item other than only indicia is attached to the garment so as to hang loosely for display within a portion of the window.
